(19) United States
(12) Patent Application Publication
(10) Pub. No.: US 2015/0189257 A1
(43) Pub. Date: Jul. 2, 2015

(54) ELECTRONIC DEVICE AND METHOD FOR CONTROLLING THE SAME

(71) Applicants: Kabushiki Kaisha Toshiba, Tokyo (JP); Toshiba Lifestyle Products & Services Corporation, Tokyo (JP)

(72) Inventor: Norihiro Yoshida, Ageo Saitama (JP)

(21) Appl. No.: 14/468,071

(22) Filed: Aug. 25, 2014

Related U.S. Application Data
(60) Provisional application No. 61/921,039, filed on Dec. 26, 2013.

(51) Int. Cl. H04N 13/04; G02B 27/22

(52) U.S. Cl. CPC H04N 13/0404; G02B 27/22

(57) ABSTRACT

According to one embodiment, an electronic device including, a display, an image mode determination module and a display characteristic setting module. The display configured to display. The image mode determination module configured to determine a mode of an image signal. The display characteristic setting module configured to set a display characteristic of the display, based on a result of the determination of the image mode determination module, to either a first characteristic applied to a first display mode or a second characteristic applied to a second display mode.

### CROSS-REFERENCE TO RELATED APPLICATIONS

This application claims the benefit of U.S. Provisional Application No. 61/921,039, filed Dec. 26, 2013, the entire contents of which are incorporated herein by reference.

### FIELD

Embodiments described herein relate generally to an electronic device and a method for controlling the same.

### BACKGROUND

An electronic device, has an image display unit, capable of displays a 3D (three-dimensional or stereoscopic) image to the image display unit have come into wide use.

In electronic device to display the 3D image, Shutter Glasses (Active Shutter) technology is known, which controls a shutter provided in a lens to turn on/turn off (open/close) in synchronization with timings of displaying a left-eye image and a right-eye image alternately.

However, in some cases, to change the brightness of the right-eye and left-eye images depending on an image display mode of the image display unit and a switch timing of the right-eye and left-eye images. The change in brightness of the right-eye and left-eye images is perceived as flicker of the displayed image by a viewer, and considered as degradation of the display image. The flicker of the image increases fatigue of the viewer's eyes and their visual nerve system (a sense of fatigue through the visual nerve system), also.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of an image display apparatus according to an embodiment;

FIG. 2 is an exemplary diagram showing an example of an image output unit according to an embodiment;

FIGS. 3A and 3B are exemplary diagrams each showing an example of an input instruction value output by the image output module versus a brightness characteristic according to an embodiment;

FIG. 4 is an exemplary diagram showing an example of an input instruction value output by the image output module versus a brightness characteristic according to an embodiment; and

FIG. 5 is an exemplary diagram showing an example of determination of an image subjected to a switch of a brightness characteristic with respect to an input instruction value output by the image output module according to an embodiment.

### DETAILED DESCRIPTION

Various embodiments will be described hereinafter with reference to the accompanying drawings.

In general, according to one embodiment, an electronic device comprising: a display, an image mode determination module and a display characteristic setting module. The display configured to display. The image mode determination module configured to determine a mode of an image signal. The display characteristic setting module configured to set a display characteristic of the display, based on a result of the determination of the image mode determination module, to either a first characteristic applied to a first display mode or a second characteristic applied to a second display mode.

Embodiments will now be described hereinafter in detail with reference to the accompanying drawings.

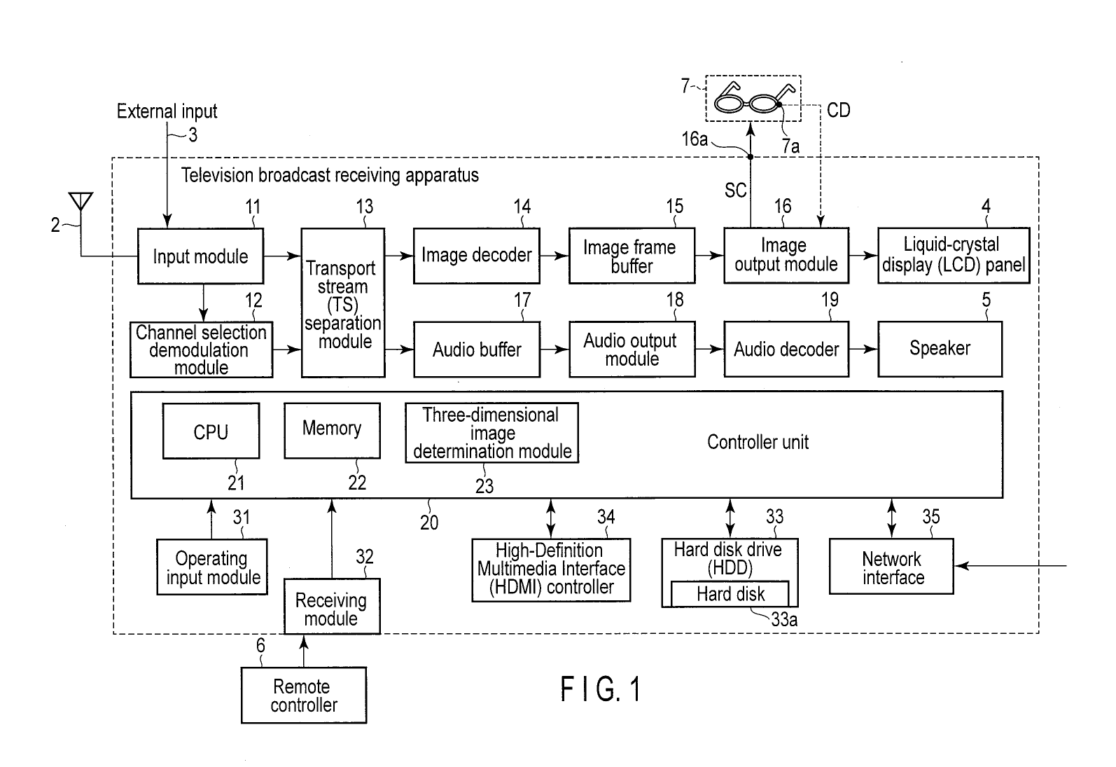

FIG. 1 shows an example of an image display apparatus (electronic device) according to an embodiment. Note that elements and structures which will be described below may be realized in software by a microcomputer (processing apparatus or central processing unit [CPU]), or in hardware. In addition, as a method for obtaining content to be displayed, using any of space waves (radio waves), using a network such as a cable (including an optical fiber) or an Internet Protocol communications, signal processing of a streaming image from a network, an image transfer technique using a network function, or the like may be employed. Note that the content includes an image and audio, music or the like, and may be called to as a stream, a program or data. Further, the image includes moved image and still image, text (data represented as strings of coded letters, marks and the like) and any combinations thereof.

An image display apparatus (electronic device) 1 is, for example, a broadcast receiving apparatus (television broadcast receiving apparatus) configured to reproduce a broadcast signal or externally input image content.

The image display apparatus 1 comprises an input module 11, a channel selection demodulation module 12, a transport stream (TS) separation module 13, an image decoder 14, an image frame buffer 15, an image output module 16, an audio buffer 17, an audio output module 18, an audio decoder 19, and the like. To the input module 11, an antenna 2 is connected. An external input 3 such as a set-top box (STB) or a recorder is also connected to the input module 11. To the image output module 16, a display apparatus 4 such as a liquid-crystal display (LCD) panel is connected. To the audio decoder 19, a speaker 5 is connected.

The image display apparatus 1 comprises a main control block (controller) 20, also. The controller 20 includes a central processing unit (CPU) 21, a memory 22, a 3D image determination module 23, and the like. Note that, the memory 22 in the controller 20 includes a read-only memory (ROM) which stores a control program to be executed by the CPU 21, a random access memory (RAM) which provides an operation area for the CPU 21, and a non-volatile memory which stores various setting data, control data and the like. To the controller 20, for example, an operation input module 31, a remote control signal receiving unit (receiving unit) 32, a hard disc drive (HDD) 33, a High-Definition Multimedia Interface (HDMI) controller 34, a network interface 35, and the like are connected.

The television broadcast signal received by the antenna 2 is input from the input module 11 to the channel selection demodulation module 12. The broadcast signal selected in the channel selection demodulation module 12 is subjected to demodulation processing and to generate a transport stream (TS) and is output. Note that the TS which is input from the external input 3 to the input module 11, is directly supplied to the TS separation module 13.

The TS output by the channel selection demodulation module 12 is separated into an image component (video) and an audio component (audio) by the TS separation module 13. The image component is decoded to a digital image signal by decode processing of the image decoder 14. The (digital) image signal decoded by the image decoder 14 is stored by an image frame buffer 15. The image signal stored in the image frame buffer 15 is read out frame by frame by the image output module 16, carried out predetermined signal processing such as a γ correction, and supplied to a display apparatus (LCD panel) 4.

An audio buffer 17 stores the audio component separated by the TS separation module 13. The audio signal stored in the audio buffer 17 is read out by the audio output module 18, and is reconstructed to digital audio data, and is converted to analog audio data by decode processing of the audio decoder 19, and is supplied to the speaker 5.

The controller 20 controls each of elements such as the LCD panel 4, the speaker 5, the channel selection demodulation module 12, the TS separation module 13, the image decoder 14, the image frame buffer 15, the image output module 16, the audio buffer 17, the audio input module 18, the audio decoder 19, and the like. The controller 20 controls the each of elements based on operating information (control input) from the operating input module 31 or from a remote controller 6 received by the receiving module (remote control signal receiving module) 32, with the CPU 21.

Based on the user's operation (control input), the controller 20 can record the image and audio signals, etc., output from the image frame buffer 15 and the audio decoder 19, in a hard disk 33a of the HDD 33. In recording the image signal and audio signal, etc., in the hard disk 33a of the HDD 33, the controller 20 processes the image signal and audio signal, etc., by encrypt processing and to convert to a predetermined recording format. Based on the user's operation by the remote controller 6 or the like, the controller 20 reads out the image signal and audio signal, etc., from the hard disk 33a of the HDD 33, subjects them to decode processing, and supplies them to the image frame buffer 15 and audio decoder 19, and performs image display and audio reproduction.

In addition, the controller 20 can supply image signal and audio signal, etc., input from other device via the HDMI controller 34 to the HDD 33, and output the image signal and audio signal, etc., stored by the HDD 33 to another device via the HDMI controller 34. Note that, the image signal and audio signal, etc., input from other device via the HDMI controller 34 can also be directly reproduced by the display apparatus 4 and speaker 5 without being stored by the HDD 33.

Further, the controller 20 can supply image signal and audio signal, etc., input from other device connected to a network, a server on a network, or the like via the network interface 35 to the HDD 33, and output the image signal and audio signal, etc., stored by the HDD 33 to another network-connected device or server on the network, etc. Note that, the image signal and audio signal, etc., input from other device via the network interface 35 can also be directly reproduced by the display apparatus 4 and the speaker 5 without being stored by the HDD 33.

The image output module 16 can recognize the content to be reproduced as a 3D image if the 3D image determination module 23 of the controller 20 detects an image signal to which a 3D content flag indicative of a stereoscopic image is attached, or if an instruction to reproduce 3D image content is received from the remote controller 6. The 3D image determination module 23 is configured to detect a 3D content flag, and it determines display output of a 3D image if a 3D content flag is detected, and determines display output of a two-dimensional (2D) image if a 3D content flag is not detected.

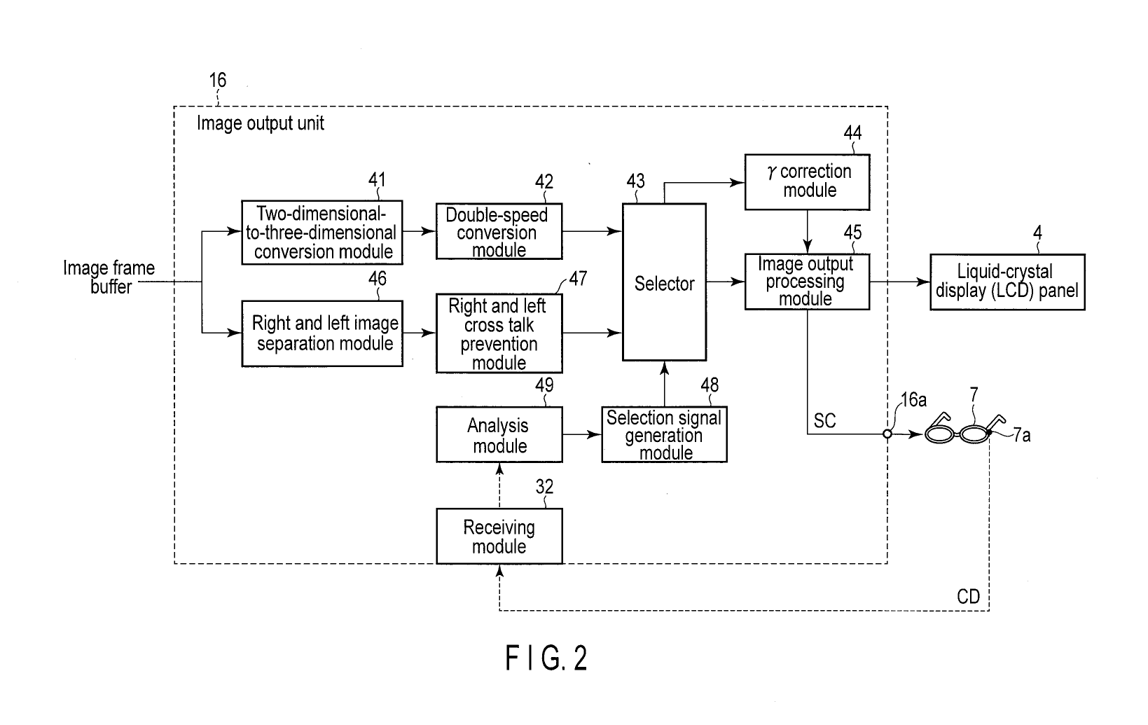

If an indication of 3D image content is detected by the 3D image determination module 23 or if an instruction to reproduce 3D image content from the remote controller 6 is received, the image output module 16 generates image signals for the right eye and left eye respectively, according to the 3D image, and outputs them to the LCD panel 4 alternately to display the 3D image. Note that the image output module 16 comprises a two-dimensional-to-three-dimensional (2D-3D) conversion module 41 (FIG. 2) configured to convert 2D image content to 3D image content. Upon receipt of an instruction to reproduce 3D image content from the remote controller 6, it is possible to convert an image signal output in a display mode of a 2D image to output it in a display mode of a 3D image.

In addition, the image output module 16 generates image signal for the right eye and image signal left eye respectively from the image signal and performs 3D image display by the LCD panel 4 with image displaying these image signals alternately, when a presence of wearing/not wearing detection signal CD informing that a user is wearing a pair of 3D glasses 7 is input and an image signal supplied from the image frame buffer 15 is a 3D image signal.

In contrast, the image output module 16 converts a received stereoscopic image signal into a 2D (normal) image signal, subjects the converted image signal for two-dimensional display to frame double-speed conversion processing so as to be displayable on the LCD panel 4, and supplies it to the LCD panel 4 for image display, when a presence of wearing/not wearing detection signal CD informing that a user is not wearing a pair of 3D glasses 7.

FIG. 2 shows the structure and processing of the image output module.

The image output module 16 includes a double-speed conversion module 42, a selector 43, a γ correction module 44, an image output processing module 45, a right and left image separation module 46, a right and left crosstalk prevention module 47, a selection signal generation module 48, an analysis module 49, and the like.

The image signal supplied from the image frame buffer 15 is supplied to the two-dimensional-to-three-dimensional (2D-3D) conversion module 41 and the right and left image separation module 46.

The two-dimensional-to-three-dimensional conversion module 41 outputs an input image signal, if it is a 2D image signal, to the double-speed conversion module 42 in a subsequent stage. Further, if a 3D image signal is input, the two-dimensional-to-three-dimensional conversion module 41 converts it into an image signal for 2D display and outputs it to the double-speed conversion module 42.

The double-speed conversion module 42 carries out frame double-speed conversion processing to the input image signal for 2D display, for example, by means of creating an interpolation frame using a motion vector between frames to be displayable on the LCD panel 4, and outputs it to the selector 43.

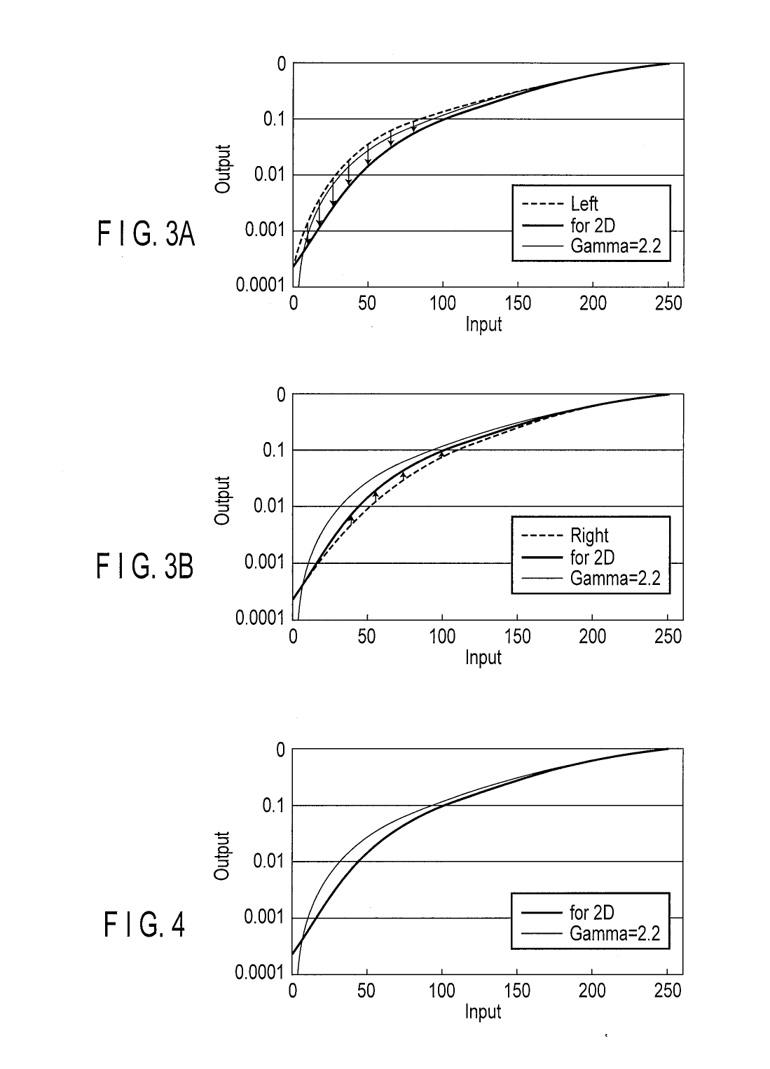

The γ correction module 44 separately sets, only in the case of a 3D image signal, output change (γ characteristic) with respect to a brightness instruction value of the LCD panel 4. The γ characteristic is separately sets, a characteristic set for a 2D image signal (for example, 0 to 255 in 8 bits), as a γ characteristic for right-eye and a γ characteristic for left-eye, which will be described later with reference to FIGS. 3A and 3B.

The right and left image separation module 46 separates, when a 3D image signal is input, the image signal into image signal for the right eye and image signal left eye and outputs these image signals alternately at double speed to the right and left crosstalk prevention module 47.

The right and left crosstalk prevention module 47 processes the alternately input right-eye image and left-eye image by interposing a black image signal therebetween to prevent interference (crosstalk) which occurs in switching between the right-eye image and left-eye image, and outputs them to the selector 43.

The selector 43 selects an image signal supplied from the double-speed conversion module 42 and right and left crosstalk prevention module 47 based on a selection signal output from the selection signal generation module 48, and outputs the selected image signal to the image output processing module 45.

The image output processing module 45 performs, depending on the switch by the selector 43, the γ correction for the right-eye image and the γ correction for the left-eye image for each image frame when an input image signal is a 3D image signal, and carries out necessary signal processing on the input image signal for image display by the LCD panel 4, and outputs it to the LCD panel 4.

Further, the image output processing module 45 generates, when the input image signal is a 3D image signal, a shutter control signal SC determining image display periods for the right-eye image and left-eye image, and outputs it to a pair of glasses for stereoscopic vision (a pair of 3D glasses) 7.

The pair of 3D glasses 7 closes, based on the shutter control signal SC which is output and supplied by an output terminal 16a of the image output module 16, either one of shutters alternately according to shutter opening/closing control synchronized with the right-eye display image and left-eye display image, wherein a right-eye shutter is opened and a left-eye shutter is closed during the right-eye image display, and the left-eye shutter is opened and the right-eye shutter is closed during the left-eye image display. In this way, a user perceives the image displayed by the LCD panel 4 as a 3D image.

The pair of 3D glasses 7 comprises a wearing/not wearing detection section 7a which determines that the user is wearing the pair of 3D glasses 7 by detecting pressure caused when the user puts them on, and configured to determine whether or not the user is wearing the pair of 3D glasses 7. The wearing/not wearing detection section 7a comprises, for example, an infrared ray output/detection unit, and is configured to transmit the wearing/not wearing detection signal CD by radio including infrared light. The wearing/not wearing detection signal CD transmitted from the wearing/not wearing detection section 7a is received, for example, by the receiving module 32, and input to the analysis module 49.

Note that, it is possible to detect that the user is wearing the pair of 3D glasses 7 by various other methods. For example, the infrared ray output/detection unit may be provided in the pair of 3D glasses 7 and be configured to detect reflected light reflected from in the pair of 3D glasses 7 infrared ray radiated from the pair of 3D glasses 7 is reflected on the LCD panel 4. It is also possible to detect whether or not the user is wearing the pair of 3D glasses 7 by inclination of the pair of 3D glasses 7.

The wearing/not wearing detection signal CD output from the wearing/not wearing detection section 7a provided in the pair of 3D glasses 7 is received by the receiving module 32 (may be provided in the image output module 16 for a purpose-built).

The analysis module 49 detects that the user is wearing the pair of 3D glasses 7, based on the wearing/not wearing detection signal CD received by the receiving module 32, the selection signal generation module 48 generates a selection signal which switches the selector 43 to lead the image signal output by the right and left crosstalk prevention module 47 to the image output processing module 45. The selector 43 switches the γ correction of the γ correction module 44, according to the selection signal from the selection signal generation module 48 such that the γ corrections for the right-eye image and left-eye image of the γ correction module 44 are reflected in the image display in the image output processing module 45.

The analysis module 49 causes the selection signal generation module 48 to generate the selection signal to switch the selector 43 so as to lead the image signal output from the double-speed conversion module 42 to the image output processing module 45, on detecting that the user is not wearing the pair of 3D glasses 7. The selector 43 switches, according to the selection signal from the selection signal generation module 48, the γ characteristic of the γ correction module 44 to the γ characteristic for 2D (normal) display, also.

Consequently, in the image output module 16, when the user removes the pair of 3D glasses 7 in a state where a stereoscopic (3D) image signal is subjected to image display on the LCD panel 4, the image signal is automatically converted from the 3D image signal to an image signal for two-dimensional display and subjected to the image display on the LCD panel 4. When the user puts on the pair of 3D glasses 7, the 3D image signal is automatically subjected to the image display on the LCD panel 4.

Further, γ corrections for the right-eye image and left-eye image with respect to a stereoscopic image signal by the γ correction module 44 can prevent brightness change of the left-eye image and right-eye image due to the image display mode of the image display unit and the timings of switching the left-eye image and right-eye image (the flicker) in the stereoscopic image.

As shown in FIGS. 3A and 3B as an example, with the γ corrections for the right-eye image and left-eye image with respect to a 3D image signal, the γ correction module 44 can prevent brightness change of the left-eye image and right-eye image due to the image display mode of the image display unit and the timings of switching the left-eye image and right-eye image (the flicker) in the stereoscopic image.

More specifically, in the LCD panel 4, usually only one output change (γ characteristic) with respect to a brightness instruction value (for example, 0-255 in 8 bits) is set for an image signal for 2D display as shown in FIG. 4.

However, in the case of a 3D image signal, the right-eye image and left-eye image signals are output alternately. In addition, an output timing of light (drive timing or drive mode of a light-emitting diode [LED]) output by a backlight (LED lighting device) is usually defined for the LCD panel 4 itself. Further, the right-eye image and left-eye image signals separated from the image signal output by the image frame buffer 15, are output by the right and left image separation module 46 usually in such an order that the image for either of the eyes is output first (if the right-eye image is set to be output before the left-eye image, the left-eye image will not be output before the right-eye image).

In this context, when the brightness change (flicker) due to a change in the brightness inherent in the drive timing and drive mode of the backlight, pseudo-synchronizes with the output timings of the left-eye image and right-eye image, a viewer perceives regards it as degradation of the display image in some cases.

Therefore, as shown in FIGS. 3A and 3B as an example, only in a case where an image signal is a 3D image signal, the γ characteristic for right-eye and the γ characteristic for left-eye are set respectively and independently. Note that, as shown in FIG. 4, the γ characteristics provided respectively for both eye images are set to be able to realize a single characteristic which is set as the γ characteristic for 2D display, to be without a difference between the right-eye and left-eye characteristics. Here, in an example shown in FIG. 3A, a γ characteristic having the output higher than that of the γ characteristic of 2D display shown in FIG. 4 can be adjusted by providing a γ characteristic (partially) reduced to coincide with the γ characteristic of 2D display. Similarly, in an example shown in FIG. 3B, a γ characteristic having the output lower than that of the γ characteristic of 2D display shown in FIG. 4 can be adjusted by providing a γ characteristic (partially) increased to coincide with the γ characteristic of 2D display shown in FIG. 3B.

Note that, the right-eye/left-eye γ characteristics (correction values) are stored, for example, in a non-volatile memory of the memory 22 at the stage of designing or assembling. Further, the right-eye/left-eye γ characteristics (correction values) may be corrected based, for example, on change in the temperature of an environment (surrounding temperature) in which the image display apparatus 1 is located, change in the temperature of the LCD panel 4, (a lapse time from the starting of image display, a lapse time from the end of display to the start of display when image display is to be restarted after the end of the image display,) or the like.

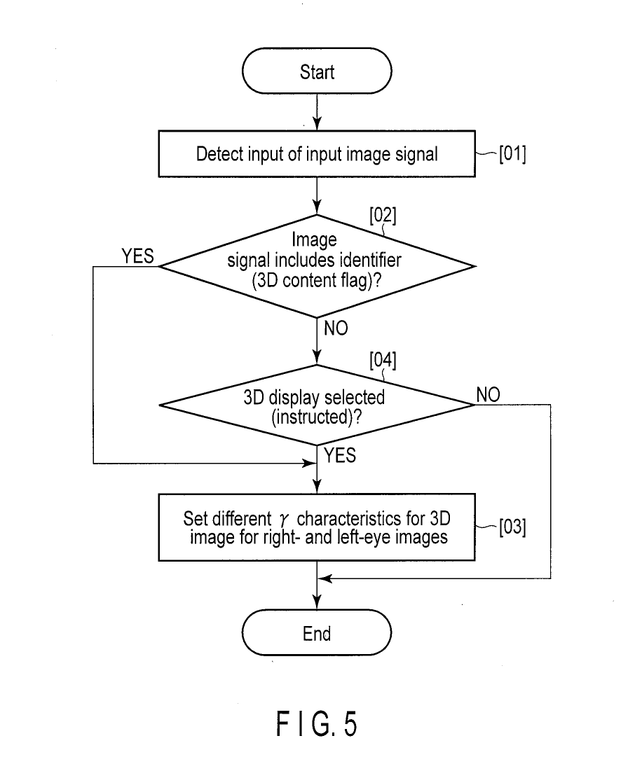

FIG. 5 shows an example of a procedure of switching the γ characteristic upon detection of an identifier (3D content flag) attached to the image signal or upon receipt of the switch input (instruction input from a remote controller by a user), in a software-based manner.

Detect input of an input image signal [01].

Detect whether or not the input image signal includes an identifier (3D content flag) [02]. If the image signal includes an identifier (3D content flag) [02-YES], set a γ characteristic of an output image signal which is to be output to the LCD panel 4, to different γ characteristics for a 3D image for the right-eye image and left-eye image [03].

When an identifier cannot be detected from the image signal [02-NO], if 3D display is selected (instructed) by user's operation [04-YES], set different γ characteristics for a 3D image for the right-eye image and left-eye image, similarly [03].

Note that, in the image display apparatus 1, with respect to a currently employed 2D (normal) image, 3D display (of image) is possible by the two-dimensional-to-three-dimensional (2D-3D) conversion module 41, thus it is desired that, if 3D display is selected (instructed) by the user's operation even when the identifier cannot be detected, the γ characteristic is also switched to the γ characteristics for a 3D image, which are separately set for the right-eye image and left-eye image.

As described above, the output change (γ characteristic) with respect to the brightness instruction value is separately set for the right- and left-eye images of the 3D image signal so as to make the brightness of the left- and right-eye images substantially the same. Thus, the occurrence of flicker of the display image can be decreased. This prevents a user from perceiving flicker and considering it as degradation of the display image. Furthermore, by reducing (preventing) the flicker, the viewer will less likely to feel fatigue of the eye and visual system (fatigue through the visual system).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display configured to display an image;
an image mode determination module configured to determine a mode of an image signal; and
a display characteristic setting module configured to set a display characteristic of the display, based on a result of the determination of the image mode determination module, to either a first characteristic applied to a first display mode or a second characteristic applied to a second display mode.

2. The electronic device of claim 1, wherein the image mode determination module is configured to determine the mode of the image signal, if to detect of an identifier attached to the image signal or to receive of a switch input.

3. The electronic device of claim 2, wherein the image characteristic setting module is configured to set the second characteristic, if the mode of the image signal is determined to be the second display mode by the image mode determination module, and configured to switch the application of the second characteristic between the right-eye image and left-eye image signals.

4. The electronic device of claim 3, wherein the display characteristic set by the display characteristic setting module is an output value of brightness with respect to an input instruction value.

5. A method to control an electronic device comprising:
determining a mode of an image signal; and
setting a display characteristic of a display based on a result of the determination to either a first characteristic applied to a 2D image or a second characteristic applied to a 3D image.

6. The method of claim 5, wherein the determination of the mode of the image signal is based on detection of an identifier attached to the image signal or on receipt of a switch input.

7. The electronic device of claim 6, wherein the second characteristic is applied if the mode of the image signal is of a 3D image, and the application of which is switched between the right-eye image and left-eye image signals.
